(19) United States
(12) Patent Application Publication
(10) Pub. No.: US 2021/0089935 A1
(43) Pub. Date: Mar. 25, 2021

(54) SYSTEM AND METHOD FOR PREDICTING ENVIRONMENTAL RESOURCE CONSUMPTION USING INTERNET-OF-THINGS AND AUGMENTED REALITY

(71) Applicant: International Business Machines Corporation, Armonk, NY (US)

(72) Inventors: Jacob Ryan Jepperson, Austin, TX (US); Zachary A. Silverstein, Jacksonville, FL (US)

(21) Appl. No.: 16/579,533

(22) Filed: Sep. 23, 2019

(51) Int. Cl. G06N 5/04; G06N 20/00

(52) U.S. Cl. CPC G06N 5/04; G06N 3/0445; G06N 20/00

(57) ABSTRACT

A computer-implemented method for determining alternative options for accomplishing an identified project and for predicting environmental resource consumption of the alternative options is provided. The method includes identifying, by a computer, a project to be accomplished by a user. The method also includes determining, by the computer, a number of options according to the project, wherein each of the options provides a way for completing the project. The method also includes determining, by the computer, a number of tasks associated with each option, and wherein each task includes an action utilized to complete at least a portion of the task according to the associated option. The method also includes identifying, by the computer, a resource consumption for each task. The method also includes determining, by the computer, a recommended one of the options according to the resource consumption.

### BACKGROUND

### 1. Field

The disclosure relates generally to computer systems and, more particularly, to computer automated methods for predicting resource consumption.

### 2. Description of the Related Art

Household tasks, such as cooking and cleaning, are a part of everyday life. Modern appliances and electronics have reduced some of the burden of completing these tasks and reduced the amount of energy and time expended on these tasks. Nevertheless, these tasks, even with modern convenient appliances required time and energy to complete. Various tasks may be completed using different methods with some methods saving time, energy, or money over other alternative methods while the alternatives may provide other benefits. Regardless of what task is performed and the method selected to accomplish a task, household tasks still consume resources.

### SUMMARY

According to one illustrative embodiment, a computer-implemented method for determining alternative options for accomplishing an identified project and for predicting environmental resource consumption of the alternative options is provided. The method includes identifying, by a computer, a project to be accomplished by a user. The method also includes determining, by the computer, a number of options according to the project, wherein each of the options provides a way for completing the project. The method also includes determining, by the computer, a number of tasks associated with each option, and wherein each task includes an action utilized to complete at least a portion of the task according to the associated option. The method also includes identifying, by the computer, a resource consumption for each task. The method also includes determining, by the computer, a recommended one of the options according to the resource consumption. According to other illustrative embodiments, a data processing system and computer program product for determining alternative options for accomplishing an identified project and for predicting environmental resource consumption of the alternative options are provided.

### BRIEF DESCRIPTION OF THE DRAWINGS

FIG. 1 is a pictorial representation of a network of data processing systems in which illustrative embodiments may be implemented;

FIG. 2 is a flowchart of a method for analyzing a user's house hold tasks, identifying viable options and alternatives, and assessing the resources required to compete each option depicted in accordance with an illustrative embodiment;

FIG. 3 is a flowchart of a method for analyzing a user's house hold tasks, identifying viable options and alternatives, and assessing the resources required to compete each option depicted in accordance with an illustrative embodiment;

FIG. 4 is a diagram that illustrates a node in a neural network in which illustrative embodiments can be implemented;

FIG. 5 is a diagram illustrating a restricted Boltzmann machine in which illustrative embodiments can be implemented;

FIG. 6 is a diagram illustrating a Deep Boltzmann machine in which illustrative embodiments can be implemented;

FIG. 7 is a diagram illustrating a wide-and-deep neural network in which illustrative embodiments can be implemented; and

FIG. 8 is a block diagram of a data processing system in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account one or more considerations. For example, the illustrative embodiments recognize and take into account that time, energy, and resources are being wasted completing house hold activities. For example, the illustrative embodiments recognize and take into account that whether it be cooking food, heating up left-overs, or cleaning, there are many different options available to complete each task, but each option presents a very different load on energy and resources. Furthermore, the illustrative embodiments recognize and take into account that without knowing the expense of choosing which option to complete house hold task, excessive energy and resources are being unnecessarily wasted.

The illustrative embodiments recognize and take into account that it would be desirable to have a method, an apparatus, a computer system, and a computer program product that predicts environmentally optimum alternatives for various house hold activities in an Internet-of-Things (IoT) and augmented reality (AR) connected space. For example, which is better for the environment, using the grill to make chicken or baking the chicken in the oven. As another example, is it better to leave a coffee pot on to keep coffee warm or to turn the coffee pot off and reheat the coffee later using a microwave.

In an illustrative embodiment, systems and methods of analyzing a user's house hold task, identifying viable options and alternatives, and assessing the inputs such as time, energy, and resource impact for each option and alternative to complete a house hold task are provided.

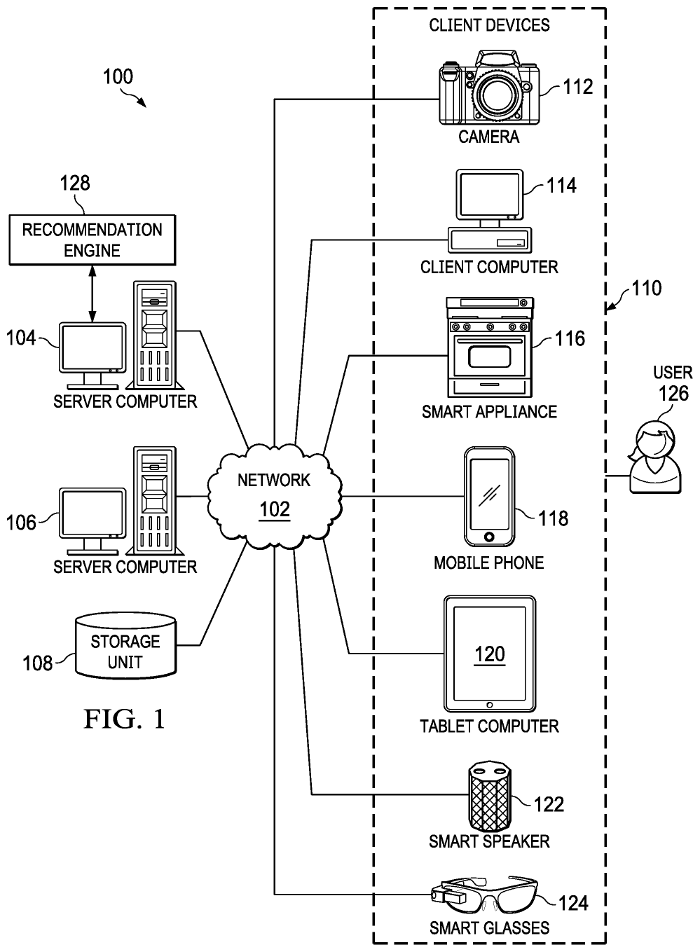

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include camera 112 and client computer 114. Further, client devices 110 can also include other types of client devices such as smart appliance 116, mobile phone 118, tablet computer 120, smart speaker 122, and smart glasses 124. Smart appliance 116 may be a smart thermostat, a smart refrigerator, a smart coffee pot, a smart washing machine, a smart drier, a smart dish washer, or other device or appliance that includes a data processor and sensors that enable the device to communicate with network 102. Client devices 110 can be, for example, computers, workstations, or network computers. In the depicted example, server computer 104 provides information, such as boot files, operating system images, and applications to client devices 110. In this illustrative example, server computer 104, server computer 106, storage unit 108, and client devices 110 are network devices that connect to network 102 in which network 102 is the communications media for these network devices.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program code located in network data processing system 100 can be stored on a computer-recordable storage medium and downloaded to a data processing system or other device for use. For example, program code can be stored on a computer-recordable storage medium on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). Network 102 may be comprised of the Internet-of-Things (IoT). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As depicted, a recommendation engine 128 executes on server computer 104. In other embodiments, recommendation engine 128 may execute on client computer 114, mobile phone 118, or tablet computer 120. Recommendation engine 128 makes recommendations about various alternatives or options available to user 126 in order to complete a desired project or task, such as cooking dinner or cleaning the house. The recommendation engine 128 ingests information about resource consumption, cost, pollution caused, and other information about various appliances, such as smart appliances 116 within the home of user 126. The home of user 126 includes multiple smart devices that observe the user 126 and the environment to determine a project (e.g., cleaning the bathroom, washing clothes, or cooking dinner) and suggests options for completing the identified project. For example, for cooking dinner, the options could include grilling chicken, cooking chicken in the oven, or cooking chicken on the stove top. Each option has different resource consumption associated with it. For example, each option for cooking chicken may utilize a different amount of energy, a different type of energy (electricity vs. gas), take a different amount of time, and have a different effect on the environment and pollution. The recommendation engine 128 takes all the information about the resource consumption to determine a recommendation for an option that optimizes resource consumption. The user may prioritize a particular type of resource. For example, the user may prefer least amount of energy as opposed to the quickest. Alternatively, the user may prefer that the option that costs the least amount of money be selected. In other embodiments, a cost benefit analysis weighing the relative benefits and costs of multiple resources with various weights given to each resource consumed in order to determine a recommended option. The weighting may vary over time and may be refined based on user selections, time of year, time of day, environmental conditions (e.g., weather), etc.

The client computer or server computer making recommendation may obtain resource consumption information used to make the recommendation from a variety of sources. Possible methods of acquiring efficiency information and resource consumption information may include direct Internet-of-Things (TOT) device integration into the AR or VA device, such as a smart vacuum tracking and remitting electrical consumption information. Another method is smart wall plugs for generic non-IOT device efficiency capturing. Integration with utility service providers may also be provided so that, for example, water consumption can be captured and associated via timestamps (e.g. household camera captures user 126 getting water for the mop at 10:15 am, and at 10:15 am the municipal water increased the user 126 water usage by 2 gallons). Another method is predictive using the devices manuals for derivation of efficiency information, such as the manual stating “A brand A vacuum will consume about 350 watts of power per minute.”

Based on the user's profile, the recommendation engine 128 will detect which task the user is undertaking, all associated ontological siblings of that task, and the efficiency usage and/or resource consumption for each task. The efficiency usage can be predicted via historical real captured data or the other steps mentioned above. This data is reconciled and processed with regards to instructional steps related to an activity to ensure the prediction is accurate (e.g., microwave for 2 minutes versus cook on stove for 10 minutes). After this information is derived, the recommendation engine 128 will show the details to the user, possibly taking into account preferences of the ranking and the associated ecological details. With this information, the user can choose which method to user to complete their intended task while saving time, energy, and resources, as well as being environmentally conscious and friendly.

In some embodiments, the recommendation engine 128 predicts future alternatives or product recommendations. For example, based on the amount of coffee user 126 drinks, does it make sense to buy a coffee pot where a ⅓ of the pot is routinely thrown out or is it better to get individual sized coffee cup coffee maker. The recommendation engine 128 ingests user preferences in making the selection or as to what options are shown. For example, user 126 may specify that they do not wish to receive an option of microwaving raw chicken. Efficiency information for recommendation engine 128 ingests maintenance cycles/services and other non-ecological efficiency information including expected price per use which may be used to visualize recoup values.

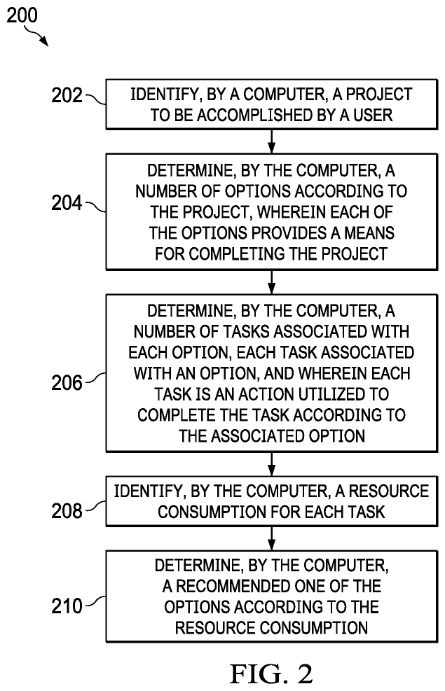

Turning now to FIG. 2, a flowchart of a method for analyzing a user's house hold tasks, identifying viable options and alternatives, and assessing the resources required to compete each option is depicted in accordance with an illustrative embodiment. The method 200 begins at step 202 where a project to be accomplished by a user is identified by a computer. The project may be identified based on a user requesting a specific task, for example, by speaking “clean clothes” or “cook chicken” into a smart speaker or the user's smart phone. In other embodiments, the project may be identified based on clues obtained from various devices, such as microphones and cameras, inside the home. For example, the computer may determine a project to be completed through conversational analysis through IOT integration of mobile devices and virtual agents scattered around the home (e.g., the computer may listen to conversations around the house and determine if the user has spoken “let's cook dinner”). The computer may also determine a project based on analysis of web searches, text messages, e-mail, and/or social media posts (e.g., the computer may monitor text messages and determine, for example, if the user has texted anyone “I'm cooking dinner”). Additionally, the computer may determine what activity a user is currently undertaking through, for example, augmented reality (AR) tutorials (e.g., how to cook chicken tutorial).

Next, at step 204, the computer determines a number of options or alternatives for completing the project according to the project, wherein each of the options provides a way for completing the project. Viable options or alternatives may be ingested through the AR viewport with optical character recognition (OCR) such as reading an instruction box or through an active tutorial. For example, the instructions may provide two different options, such as a microwave option and a conventional oven option. Based on other information about the user's oven and microwave, the computer may use the instructions combined with knowledge of the features of the user's appliances to calculate, for example, energy usage for each option. This can also be ingested through a semantic ontology tree of possible actions based on user previous interactions captured via a virtual agent with IOT listeners.

Next, at step 206, the computer determines a number of tasks associated with each option, where each task is associated with an option and each task is an action utilized to complete the at least a portion of the project according to the associated option.

Next, at step 208, the computer identifies a resource consumption for each task. The resource consumed may be several resources. For example, the computer may consider both energy consumption and time consumption. In other embodiments, only a single resource is considered. In yet other embodiments, more than two resources are considered. In an embodiment, the resource consumption includes one or more of energy consumption, time consumption, financial cost, pollution, and water consumption. The computer may also identify the type of energy consumed by a given task. For example, the same project may be accomplished by means of an electric operated appliance and by a natural gas operated appliance. Depending on the specific circumstances, there may be reasons to prefer electric appliances to gas appliances, or vice versa. Resource consumption may also consider the wear and tear imposed on a particular appliance or device by using it to complete the project and estimate a depreciation cost associated with use or how quickly use of the appliance will cause the appliance to wear out and need to be replaced. The computer may quantify this wear and tear in a score or cost that can be used to compare different resources. The energy, electricity, gas, water, time, and other various resources that are used by a given option may be determined based on actively monitoring resource consumption of various devices, such as through a smart thermostat or other smart device, from user manuals, from internet resources, from user input, or from any other source available to the computer. The best source may be actual consumption history of the device in the home, but this information may not always be available. The computer may then use next best sources of information to make its resource usage calculations. The computer may employ machine learning to improve its algorithms for determining resource consumption as well as to improve its data. In one exemplary scenario, the computer may use manuals for estimating resource consumption initially, but over time, as it acquires more actual data from the home, this data may be replaced with historic resource usage data in order to make resource consumption estimates.

Next, at step 210, the computer determines a recommended one of the options according to resource consumption. The recommended option may be determined based on, for example, which one of the options uses the least energy, costs the least money to use (i.e., has the least financial cost), takes the least time, uses the least water, produces the least air pollution, produces the least water pollution, uses the quietest appliances, machines, or devices to accomplish the project, and/or has the least impact on wear and tear of the appliances. The computer may balance various resources when multiple resources are considered in determining a recommendation. For example, the recommended option may not be the option that consumes the least energy nor the option that is the quickest, but may be a third option that is reasonably energy efficient while also being reasonably quick. The particular resource to be most optimized may be user selected and/or may be time, environment, user, and task dependent. For example, on some days, it may be more desirable to select an option for cooking dinner that is quickest because the user needs to eat quickly and then leave for an activity, while on other days, the option for cooking dinner may be the option that produces the least heat inside the house because the temperature outside is very hot and utilizing a cooking option that produces the least heat will cause the air conditioner for the house to not need to work as hard to keep the house comfortably cool.

In one illustrative embodiment, the computer may also automatically cause the recommended option to be implemented. For example, if the project is cooling the house, the options may include running the air conditioner, lowering the blinds, running the ceiling fans, or some combination of two or more of these options. The computer may determine the best option that satisfies various user preferences is running a ceiling fan and may then turn the ceiling fan on without further input from the user.

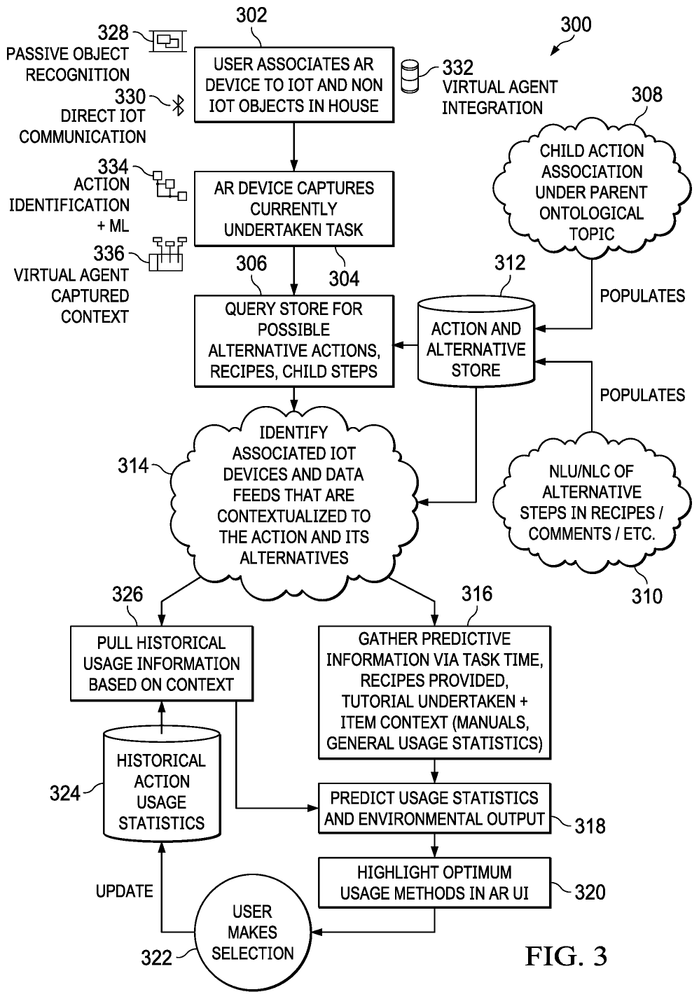

Turning now to FIG. 3, a flowchart of a method for analyzing a user's house hold tasks, identifying viable options and alternatives, and assessing the resources required to compete each option is depicted in accordance with an illustrative embodiment. Method 300 may receive efficiency information, resource information, and other information about the devices within the home or household from passive object recognition 328, direct IOT communication 330, virtual agent integration 332, action identification plus machine learning (ML) 334, and virtual agent captured context 336. Method 300 may begin at step 302 where a user associates AR device to IOT and non-IOT objects in the house. IOT devices may include virtual agents, such as smart speaker 122, augmented reality glasses, such as smart glasses 124, and standard IOT devices (e.g., smart refrigerators, smart cameras, etc.).

Next, at step 304, the AR device captures a currently undertaken task. The IOT devices determine context of a user's interaction. For example, did the user say “I'm cleaning up”, did the smart vacuum turn on, did the smart camera capture the user washing dishes, did the AR glasses capture the user starting a tutorial.

A recommendation engine, such as recommendation engine 128, may, at step 308, acquire child actions associated with parent projects or tasks and populate an action and alternative action storage 312. For example, does the user have multiple child actions associated with a general top level action (e.g., cleaning includes mopping, tidying up, vacuuming, etc.). The recommendation engine, at step 310, may also acquire alternative steps in recipes, comments, household tasks, etc. and populate action and alternative action storage 312. In other words, what alternative actions does the user have via associated core level actions. For example, does the tutorial have multiple methods of doing the same action or do users in the tutorial recommend a specific different interaction method. This data can be presented or crawled by an application building on ontology tree of associated TOT interactions with each task. This information of alternatives can be crowdsourced via other user inputs into a similar engine to capture intent and alternatives to a core task.

At step 306, the recommendation engine may query storage 312 for possible alternative actions, recipes, child steps, etc. Next, at step 314, the recommendation engine identifies associated TOT devices and data feeds that are contextualized to the actions and its alternatives. Each alternative is associated with an TOT device or data related to the intent via an TOT device. The associations may be direct or indirect. An example of a direct association may be that the phrase “do the laundry” is associated with TOT interaction with a smart washing machine. An example of an indirect association may be that the phrase “do the dishes” is associated with an interaction with a dumb sink (i.e., a sink that is not a smart sink, a sink that does not have a data processing system incorporated into it) that has correlation with global water usage details connected via utilities. The detected interaction can be searched for direct associations through known TOT derivation methods and AR image recognition. The detected interaction can also utilize NLC/NLU query and intent processing to determine an associated TOT device. The detected interaction can also search for indirect association via known neural network machine learning algorithms to derive other correlated but non-obvious factors.

At step 316, the recommendation engine gathers predictive information via task time, recipes provided, tutorials undertaken, and item context (e.g., manuals, general usage statistics, etc.). Next, at step 318, the recommendation engine predicts usage statistics and environmental output (e.g. resource consumption, cost, pollution caused, etc.) based on the predictive information gathered and on historical usage information acquired at step 326. The recommendation engine may capture efficiency information through multiple data input methods. These methods include targeted global associated data, smart plugs, smart devices, and NLC/NLU manual processing. Targeted global associated data is where certain data is connected to the smart home such as electric usage from a utility or water usage seen at an online portal that can be queried. Smart plugs may be used throughout the house and can be utilized to gather energy efficiency information. Smart devices may include smart learning thermostats, smart vacuums, and smart refrigerators which can output data directly to the recommendation engine thereby providing usage and ecological footprint details. NLC/NLU manual processing are manuals of specific IO or dumb objects that can be ingested into the recommendation engines knowledge base. These manuals often have the power usage that the recommendation engine can use to predict a baseline.

Next, at step 320, the recommendation engine highlights optimum usage methods in AR user interface (UI) and, at step 322, a user makes a selection. The recommendation engine captures the interaction method for the current intended action by utilizing historical processing of a user's previous interactions with the alternatives, the usage of those alternatives in relation to the action, and the length of time related. The recommendation engine takes the alternatives and compares valuable usage statistics such as time, ecological footprint, water consumption, and electrical consumption. Based on the optimum choice derived by the recommendation engine, the recommendation engine may visually overlay this information and the optimum choice inside the VR environment, such as via smart glasses 124, or remits this information back to the user via a virtual audio (VA) audio statement, such as via smart speaker 122.

From the user selection, a historical action usage statistics storage 324 is updated providing a feedback loop to put historical usage information based on context at step 326 which may be provided to step 318. Thus, the recommendation engine is constantly learning and improving based on prior actions.

Following is a use case example where the action is washing clothes. The recommendation engine may provide two options, one using a smart sink and one using a smart washing machine. Table 1 below provides a comparison of the water usage, energy consumed, and time taken for each alternative.

TABLE 1

| Option | Water Usage | Energy Consumed | Time |
|---|---|---|---|
| Smart Sink | 4 gallons | 5 watts | 47 minutes |
| Smart Washing | 30 gallons | 500 watts | 4 minutes |
| Machine | | | |

As can be seen, the smart sink is superior to the smart washing machine in both limiting water usage and limiting energy consumption. However, the smart washing machine is superior to the smart sink in time taken to wash the clothes. The option recommended may be made based on which of these factors is considered more important by the user based on received user preferences.

As another use case example, consider optimum coffee reheating. A user finishes making a pot of coffee using their coffee maker and pours a cup of coffee. The user's AR device recognizes there is still coffee left in the pot. The AR device identifies alternative heating options for the coffee, such as a microwave and a stove. The recommendation engine calculates the time, energy, and resource impact of each option including the breakdown time between leaving the coffee pot on versus using the microwave or stove using TOT capabilities. Using the AR device, the recommendation engine presents the user with the breakeven time of 20 minutes, meaning if the user wants another cup of hot coffee within 20 minutes, it is less resource intensive to keep the coffee pot on. However, if the user wants another cup of hot coffee after 20 minutes, it is less resource intensive to turn off the coffee pot now and use the microwave for 1 minute to reheat the coffee. The recommendation engine may also present the time, energy, and resource metrics for the stove, which may prove to be more wasteful than the coffee pot or microwave. If the user knows that they will be busy and not finish the cup of coffee within 20 minutes, then they turn off the coffee pot to save energy and resources, and later pour another cup of coffee and reheat it in the microwave. In an illustrative embodiment, the recommendation engine captures this user pattern through TOT and machine learning, automatically turns off the coffee pot the next day after the user pours the first cup of coffee knowing that the user will not be back for another cup for more than 20 minutes based on their work calendar retrieved from their phone or laptop, and therefore, is less resource intensive to just reheat using the microwave after the user's meetings conclude.

As another use case example, consider the task or project of cooking chicken. The user pulls out chicken for dinner and using an AR device, such as from camera 112, mobile phone 118, or smart glasses 124, the food is recognized. Using TOT and previous interaction, the recommendation engine knows that the stove, oven, and grill can be used to cook the chicken. Cooking instructions pulled up on the user's phone or AR device are communicated through the TOT for the recommendation engine to know the preparation needs. The recommendation engine analyzes the recipe's cooking instructions and equivalent time, energy, and resource load for each cooking option and presents the results to the user. The stove and grill may have comparable resource impacts, but the user prefers the additive taste from the grill and chooses that cooking option.

As another use case example, consider household cleaning. A user pulls out a vacuum to indicate the action of cleaning floors. The AR device recognizes the object, uses machine learning and TOT to identify alternative options to cleaning floors, including sweeping, and mopping. The recommendation engine captures, analyzes, asses, and predicts the resource consumption required to clean the floors with each of the alternative options. The recommendation engine considers electricity and resource consumption used by the vacuum as well as water and other resources used to sweep and mop. Through an AR device, such as smart glasses 124, the recognition engine displays all consumed energy and resources including predicted time to complete the task to the user, informing them that sweeping and mopping is less resource intensive and more environmentally friendly, but will take more time to clean the floors.

Turning now to a discussion of embodiments of machine learning in which one or more aspects of the illustrative embodiments may be implemented, there are three main categories of machine learning: supervised, unsupervised, and reinforcement learning. Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

Whereas supervised and unsupervised methods learn from a dataset, reinforcement learning methods learn from interactions with an environment. Algorithms such as Q-learning are used to train the predictive model through interacting with the environment using measurable performance criteria.

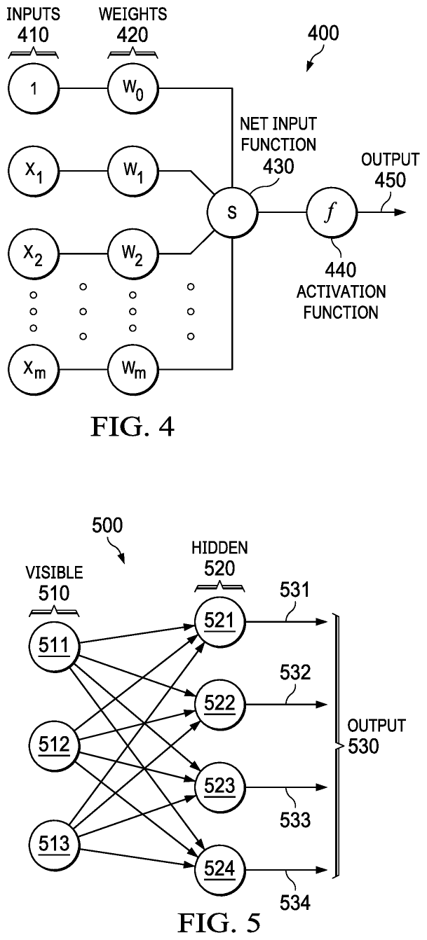

FIG. 4 is a diagram that illustrates a node in a neural network in which illustrative embodiments can be implemented. Node 400 combines multiple inputs 410 from other nodes. Each input 410 is multiplied by a respective weight 420 that either amplifies or dampens that input, thereby assigning significance to each input for the task the algorithm is trying to learn. The weighted inputs are collected by a net input function 430 and then passed through an activation function 440 to determine the output 450. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer's output acts as the next layer's input.

Stochastic neural networks are a type of network that incorporate random variables, which makes them well suited for optimization problems. This is done by giving the nodes in the network stochastic (randomly determined) weights or transfer functions. A Boltzmann machine is a type of stochastic neural network in which each node is binary valued, and the chance of it firing depends on the other nodes in the network. Each node is a locus of computation that processes an input and begins by making stochastic decisions about whether to transmit that input or not. The weights (coefficients) that modify inputs are randomly initialized.

Boltzmann machines optimize weights and quantities and are particularly well suited to represent and solve difficult combinatorial problems. To solve a learning problem, a Boltzmann machine is shown a set of binary data vectors and must find weights on the connections so that the data vectors are good solutions to the optimization problem defined by those weights.

FIG. 5 is a diagram illustrating a restricted Boltzmann machine in which illustrative embodiments can be implemented. As shown in FIG. 5, the nodes in the Boltzmann machine 500 are divided into a layer of visible nodes 510 and a layer of hidden nodes 520. A common problem with general Boltzmann machines is that they stop learning correctly when they are scaled up. Restricted Boltzmann machines (RBMs) overcome this problem by using an architecture that does not allow connections between nodes in the same layer. As can be seen in FIG. 5, there is no intralayer communication between nodes.

The visible nodes 510 are those that receive information from the environment (i.e. a set of external training data). Each visible node in layer 510 takes a low-level feature from an item in the dataset and passes it to the hidden nodes in the next layer 520. When a node in the hidden layer 520 receives an input value x from a visible node in layer 510 it multiplies x by the weight assigned to that connection (edge) and adds it to a bias b. The result of these two operations is then fed into an activation function which produces the node's output.

In symmetric networks such as Boltzmann machine 500, each node in one layer is connected to every node in the next layer. For example, when node 521 receives input from all of the visible nodes 511-513 each x value from the separate nodes is multiplied by its respective weight, and all of the products are summed. The summed products are then added to the hidden layer bias, and the result is passed through the activation function to produce output 531. A similar process is repeated at hidden nodes 522-524 to produce respective outputs 532-534. In the case of a deeper neural network (discussed below), the outputs 530 of hidden layer 520 serve as inputs to the next hidden layer.

Training a Boltzmann machine occurs in two alternating phases. The first phase is the “positive” phase in which the visible nodes' states are clamped to a particular binary state vector sampled from the training set (i.e. the network observes the training data). The second phase is the “negative” phase in which none of the nodes have their state determined by external data, and the network is allowed to run freely (i.e. the network tries to reconstruct the input). In the negative reconstruction phase the activations of the hidden layer 520 act as the inputs in a backward pass to visible layer 510. The activations are multiplied by the same weights that the visible layer inputs were on the forward pass. At each visible node 511-513 the sum of those products is added to a visible-layer bias. The output of those operations is a reconstruction r (i.e. an approximation of the original input x).

On the forward pass, the RBM uses inputs to make predictions about node activations (i.e. the probability of output given a weighted input x). On the backward pass, the RBM is attempting to estimate the probability of inputs x given activations a, which are weighted with the same coefficients as those used on the forward pass. The bias of the hidden layer helps the RBM to produce activations on the forward pass. Biases impose a floor so that at least some nodes fire no matter how sparse the input data. The visible layer bias helps the RBM learn the reconstructions on the backward pass.

Because the weights of the RBM are randomly initialized the difference between the reconstructions and the original inputs is often large. That error is then backpropagated against the RBM's weights in an iterative learning process, and the weights are adjusted until an error minimum is reached.

In machine learning, a cost function estimates how the model is performing. It is a measure of how wrong the model is in terms of its ability to estimate the relationship between input x and output y. This is expressed as a difference or distance between the predicted value and the actual value. The cost function (i.e. loss or error) can be estimated by iteratively running the model to compare estimated predictions against known values of y during supervised learning. The objective of a machine learning model, therefore, is to find parameters, weights, or a structure that minimizes the cost function.

Gradient descent is an optimization algorithm that attempts to find a local or global minima of a function, thereby enabling the model to learn the gradient or direction that the model should take in order to reduce errors. As the model iterates, it gradually converges towards a minimum where further tweaks to the parameters produce little or zero changes in the loss. At this point the model has optimized the weights such that they minimize the cost function.

Neural networks can be stacked to created deep networks. After training one neural net, the activities of its hidden nodes can be used as training data for a higher level, thereby allowing stacking of neural networks. Such stacking makes it possible to efficiently train several layers of hidden nodes. Examples of stacked networks include deep belief networks (DBN), deep Boltzmann machines (DBM), convolutional neural networks (CNN), recurrent neural networks (RNN), and spiking neural networks (SNN).

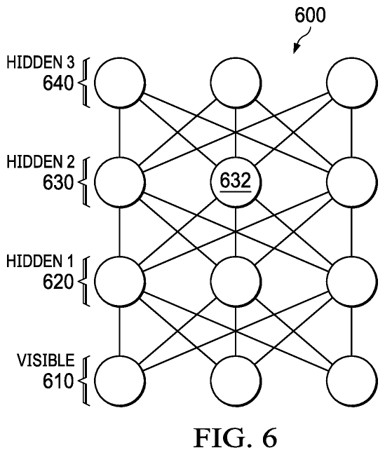

FIG. 6 is a diagram illustrating a Deep Boltzmann machine in which illustrative embodiments can be implemented. A Deep Boltzmann machine (DBM) is a network of symmetrically coupled stochastic binary nodes, comprising a layer of visible nodes 610 and multiple layers of hidden nodes 620-640. Like RBMs, the Deep Boltzmann machine 600 has no connections between nodes in the same layer. It should be understood that the number of nodes and layers depicted in FIG. 6 is chosen merely for ease of illustration and that the present disclosure can be implemented using more or less nodes and layers that those shown.

DBMs learn the hierarchical structure of features, wherein each subsequent layer in the DBM processes more complex features than the layer below it. For example, in FIG. 6, the first hidden layer 620 might process low-level features, such as, e.g., the edges of an image. The next hidden layer up 630 would process higher-level features, e.g., combinations of edges, and so on. This process continues up the layers, learning simpler representations and then composing more complex ones.

The DBM is created by first separately pre-training each RBM in a stack and then combining them to form a single DBM. A key characteristic of DBMs is that all of the connections between the layers are undirected, as depicted in FIG. 6, meaning signals can travel in both directions between nodes and layers. This undirected architecture allows the DBM 600 to apply inference and learning procedures using both bottom-up and top-down passes, thereby producing dependencies between hidden variables in both directions, not just from the layers below. For example, in FIG. 6, the state of hidden variable 632 is dependent on the states of the hidden variables in both layers 620 and 640. This allows the DBM to handle uncertainty more effectively than other deep networks that rely solely on bottom-up, feed forward learning.

In bottom-up sequential learning, the weights are adjusted at each new hidden layer until that layer is able to approximate the input from the previous lower layer. In contrast, the undirected architecture of DBMs allows the joint optimization of all levels, rather than sequentially up the layers of the stack.

DBMs perform well in many application domains. They are capable of fast inference in a fraction of a second, and learning can scale to millions of examples.

Another type of neural network that more closely simulates the functioning of biological systems is a Spiking Neural Network (SNN). SNNs incorporate the concept of time into their operating model. One of the most important differences between SNNs and other types of neural networks is the way information propagates between units/nodes.

Whereas other types of neural networks communicate using continuous activation values, communication in SNNs is done by broadcasting trains of action potentials, known as spike trains. In biological systems, a spike is generated when the sum of changes in a neuron's membrane potential resulting from pre-synaptic stimulation crosses a threshold. This principle is simulated in artificial SNNs in the form of a signal accumulator that fires when a certain type of input surpasses a threshold. The intermittent occurrence of spikes gives SNNs the advantage of much lower energy consumption than other types of neural networks. A synapse can be either excitatory (i.e. increases membrane potential) or inhibitory (i.e. decreases membrane potential). The strength of the synapses (weights) can be changed as a result of learning.

Information in SNNs is conveyed by spike timing, including latencies and spike rates. SNNs allow learning (weight modification) that depends on the relative timing of spikes between pairs of directly connected nodes. Under the learning rule known as spike-timing-dependent plasticity (STDP) the weight connecting pre- and post-synaptic units is adjusted according to their relative spike times within a specified time interval. If a pre-synaptic unit fires before the post-synaptic unit within the specified time interval, the weight connecting them is increased (long-term potentiation (LTP)). If it fires after the post-synaptic unit within the time interval, the weight is decreased (long-term depression (LTD)).

The leaky integrate-and-fire (LIF) neuron has been a primary area of interest for the development of an artificial neuron and is a modified version of the original integrate-and-fire circuit. The LIF neuron is based on the biological neuron, which exhibits the following functionalities:

1) Integration: Accumulation of a series of input spikes,

2) Leaking: Leaking of the accumulated signal over time when no input is provided, and

3) Firing: Emission of an output spike when the accumulated signal reaches a certain level after a series of integration and leaking.

A LIF neuron continually integrates the energy provided by inputs until a threshold is reached and the neuron fires as a spike that provides input to other neurons via synapse connections. By emitting this spike, the neuron is returned to a low energy state and continues to integrate input current until its next firing. Throughout this process, the energy stored in the neuron continually leaks. If insufficient input is provided within a specified time frame, the neuron gradually reverts to a low energy state. This prevents the neuron from indefinitely retaining energy, which would not match the behavior of biological neurons.

Lateral inhibition is a process that allows an excited neuron to inhibit, or reduce, the activity of other nearby or connected neurons. One such neural computing system that seeks to take advantage of this is the winner-take-all system. As a form of competitive learning, artificial neurons contend for activation, meaning that only one neuron is chosen as the winner and allowed to fire, using lateral inhibition to suppress the output of all other neurons. After the winning neuron fires, the system is reset and the neurons once again compete for activation. A winner-take-all system is one of the many machine learning paradigms that take advantage of the lateral inhibition phenomenon, which is commonly used in recognition and modeling processes.

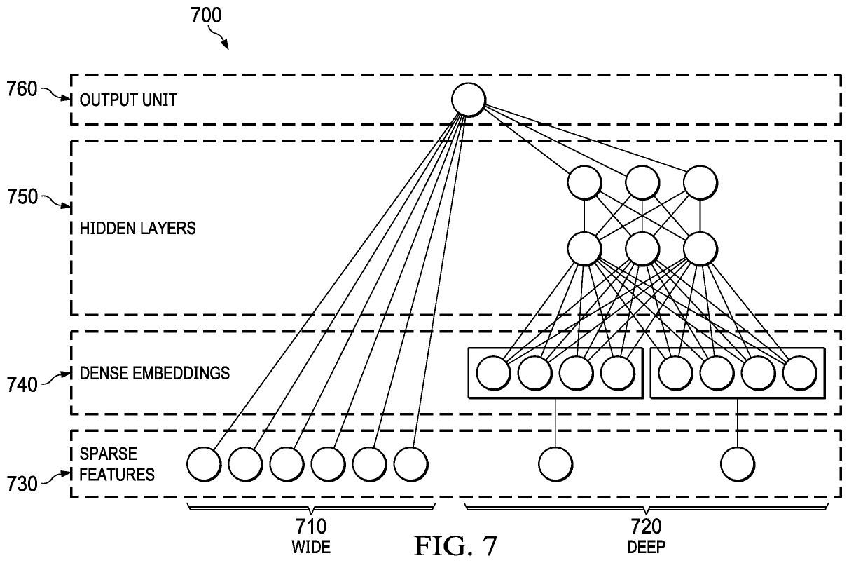

FIG. 7 is a diagram illustrating a wide-and-deep neural network in which illustrative embodiments can be implemented. Wide-and-deep model 700 comprises two main parts, a wide linear part 710 and a deep part 720. Wide part 710 is responsible for learning and memorizing the co-occurrence of particular dimensions within a data set. Deep part 720 learns complex relationships among individual dimensions in the data set. Stated more simply, deep part 720 develops general rules about the data set, and wide part 710 memorizes exceptions to those rules.

Wide-and-deep model 700 comprises a plurality of layers. The first two layers comprise sparse features 730 and dense embeddings 740. Features refer to properties of a phenomenon being modelled that are considered to have some predictive quality. Sparse features 730 comprise features with mostly zero values. Sparse feature vectors represent specific instantiations of general features can could have thousands or even millions of possible values, hence why most of the values in the vector are zeros. For example, a vocabulary might have a vast number of words, and each word is represented by a large vector comprised mostly of zero values. For a given word, the number of dimensions in the vector equals the number of words in the vocabulary, and the dimension representing the word within the vocabulary has a value of 1, and the remaining dimensions (representing the other words) have a value of zero.

The wide part 710 of the wide-and-deep model 700 learns using these sparse features 730, which is why it is able to remember specific instances and exceptions.

Dense embeddings 740, in contrast, comprise mostly non-zero values. An embedding is a dense, relatively low-dimensional vector space into which high-dimension sparse vectors can be translated. Embedding making machine learning easier to do on large inputs like sparse vectors representing words. In a dense embedding, words are represented by dense vectors, wherein the vector represents the projection of the word into a continuous vector space. Individual dimensions in these vectors typically have no inherent meaning, but rather it is the pattern of location and distance between vectors that machine learning uses. The position of a word within the vector space is learned from context and is based on the words that surround it when used.

Ideally, dense embeddings capture semantics of the input by placing semantically similar inputs close together in the embedding space. It is from these semantics that the deep part of 720 of the wide-and-deep model 700 is able to generalize rules about the input values. The deep embeddings 740 mapped from the spare features 710 serves as inputs to the hidden layers 750 of the deep part 720.

Left to itself, the wide part 710 would overfit predictions by learning the specific instances represented in the sparse features 730. Conversely, by itself the deep part 720 would over generalize from the dense embeddings 740, producing rules that are over or under inclusive in their predictions. Therefore, the wide-and-deep model 700 trains both parts concurrently by feeding them both into a common output unit 760. During learning, the value of output unit 760 is back propagated back through both the wide part 710 and deep part 720 as described above. The end result is a model that can accurately predict results from general rules while able to account for specific exceptions to those rules.

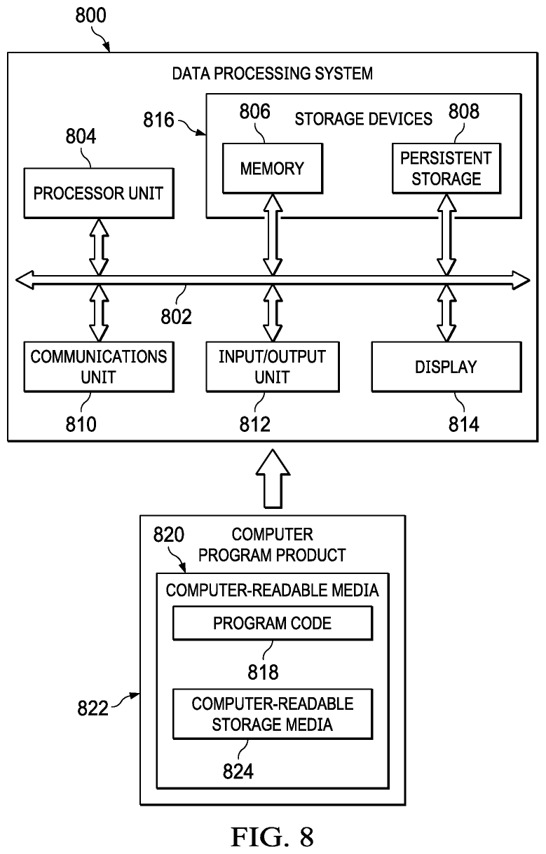

Turning now to FIG. 8, a block diagram of a data processing system is depicted in accordance with an illustrative embodiment. Data processing system 800 can be used to implement server computer 104, server computer 106, and/or one or more of client devices 110, in FIG. 1. Data processing system 800 can also be used to implement computer system 202 in FIG. 2. In this illustrative example, data processing system 800 includes communications framework 802, which provides communications between processor unit 804, memory 806, persistent storage 808, communications unit 810, input/output (I/O) unit 812, and display 814. In this example, communications framework 802 takes the form of a bus system.

Processor unit 804 serves to execute instructions for software that can be loaded into memory 806. Processor unit 804 includes one or more processors. For example, processor unit 804 can be selected from at least one of a multicore processor, a central processing unit (CPU), a graphics processing unit (GPU), a physics processing unit (PPU), a digital signal processor (DSP), a network processor, or some other suitable type of processor. For example, further, processor unit 804 can may be implemented using one or more heterogeneous processor systems in which a main processor is present with secondary processors on a single chip. As another illustrative example, processor unit 804 can be a symmetric multi-processor system containing multiple processors of the same type on a single chip.

Memory 806 and persistent storage 808 are examples of storage devices 816. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 816 may also be referred to as computer-readable storage devices in these illustrative examples. Memory 806, in these examples, can be, for example, a random-access memory or any other suitable volatile or non-volatile storage device. Persistent storage 808 may take various forms, depending on the particular implementation.

For example, persistent storage 808 may contain one or more components or devices. For example, persistent storage 808 can be a hard drive, a solid-state drive (SSD), a flash memory, a rewritable optical disk, a rewritable magnetic tape, or some combination of the above. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs can be located in storage devices 816, which are in communication with processor unit 804 through communications framework 802. The processes of the different embodiments can be performed by processor unit 804 using computer-implemented instructions, which may be located in a memory, such as memory 806.

These instructions are referred to as program code, computer usable program code, or computer-readable program code that can be read and executed by a processor in processor unit 804. The program code in the different embodiments can be embodied on different physical or computer-readable storage media, such as memory 806 or persistent storage 808.

Program code 818 is located in a functional form on computer-readable media 820 that is selectively removable and can be loaded onto or transferred to data processing system 800 for execution by processor unit 804. Program code 818 and computer-readable media 820 form computer program product 822 in these illustrative examples. In the illustrative example, computer-readable media 820 is computer-readable storage media 824.

In these illustrative examples, computer-readable storage media 824 is a physical or tangible storage device used to store program code 818 rather than a medium that propagates or transmits program code 818.

Alternatively, program code 818 can be transferred to data processing system 800 using a computer-readable signal media. The computer-readable signal media can be, for example, a propagated data signal containing program code 818. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

The different components illustrated for data processing system 800 are not meant to provide architectural limitations to the manner in which different embodiments can be implemented. In some illustrative examples, one or more of the components may be incorporated in or otherwise form a portion of, another component. For example, memory 806, or portions thereof, may be incorporated in processor unit 804 in some illustrative examples. The different illustrative embodiments can be implemented in a data processing system including components in addition to or in place of those illustrated for data processing system 800. Other components shown in FIG. 8 can be varied from the illustrative examples shown. The different embodiments can be implemented using any hardware device or system capable of running program code 818.

Thus, illustrative embodiments of the present invention provide a computer implemented method, computer system, and computer program product for generating lyrics for poetic compositions. The method determines a theme randomly or from input and, from the theme, the method determines words that are associated with the theme and words that rhyme with the associated words according to a star schema approach. The method provides a filter and other mechanisms to tailor the output to fit a specified sentiment, topic, or other feature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer-implemented method for determining alternative options for accomplishing an identified project and for predicting environmental resource consumption of the alternative options, comprising:
identifying, by a computer, a project to be accomplished by a user;
determining, by the computer, a number of options according to the project, wherein each of the options provides a way for completing the project;
determining, by the computer, a number of tasks associated with each option, and wherein each task includes an action utilized to complete at least a portion of the task according to the associated option;
identifying, by the computer, a resource consumption for each task; and
determining, by the computer, a recommended one of the options according to the resource consumption.

2. The method of claim 1, further comprising:
presenting the recommendation to the user.

3. The method of claim 1, wherein determining the recommended one of the options further comprises determining the recommended one of the options according to user preferences.

4. The method of claim 1, further comprising:
automatically performing the recommended option.

5. The method of claim 1, wherein the resource consumption comprises one of energy consumption, time consumption, financial cost, pollution, and water consumption.

6. The method of claim 1, wherein the resource consumption comprises usage of an appliance.

7. The method of claim 1, wherein determining, by the computer, the recommended one of the options according to the resource consumption comprises balancing different resource consumptions according to a user preference.

8. A computer system for determining alternative options for accomplishing an identified project and for predicting environmental resource consumption of the alternative options, the computer system comprising:
a bus system;
a storage device connected to the bus system, wherein the storage device stores program instructions; and
a processor connected to the bus system, wherein the processor executes the program instructions to:
identify a project to be accomplished by a user;
determine a number of options according to the project, wherein each of the options provides a way for completing the project;
determine a number of tasks associated with each option, and wherein each task includes an action utilized to complete at least a portion of the task according to the associated option;
identify a resource consumption for each task; and
determine a recommended one of the options according to the resource consumption.

9. The computer system of claim 8, wherein the program instructions to further comprise instructions to:
presenting the recommendation to the user.

10. The computer system of claim 8, wherein the instructions to determine the recommended one of the options further comprises instructions to determine the recommended one of the options according to user preferences.

11. The computer system of claim 8, wherein the program instructions to further comprise instructions to:
automatically perform the recommended option.

12. The computer system of claim 8, wherein the resource consumption comprises one of energy consumption, time consumption, financial cost, pollution, and water consumption.

13. The computer system of claim 8, wherein the resource consumption comprises usage of an appliance.

14. The computer system of claim 8, wherein the program instructions to determine the recommended one of the options according to the resource consumption comprises instructions to balance different resource consumptions according to a user preference.

15. A computer program product for determining alternative options for accomplishing an identified project and for predicting environmental resource consumption of the alternative options, the computer program product comprising a computer readable storage medium having program instructions embodied therewith, the program instructions executable by a computer to cause the computer to perform a method comprising:
identifying a project to be accomplished by a user;
determining a number of options according to the project, wherein each of the options provides a way for completing the project;
determining a number of tasks associated with each option, and wherein each task includes an action utilized to complete at least a portion of the task according to the associated option;
identifying a resource consumption for each task; and
determining a recommended one of the options according to the resource consumption.

16. The computer program product of claim 15, wherein the program instructions executable by the computer to further cause the computer to perform a method comprising:
presenting the recommendation to the user.

17. The computer program product of claim 15, wherein the program instructions executable by the computer to cause the computer to perform a method comprising determining the recommended one of the options further comprises program instructions executable by the computer to cause the computer to perform a method comprising determining the recommended one of the options according to user preferences.

18. The computer program product of claim 15, wherein the program instructions executable by the computer to further cause the computer to perform a method comprising:
automatically performing the recommended option.

19. The computer program product of claim 15, wherein the resource consumption comprises one of energy consumption, time consumption, financial cost, pollution, and water consumption.

20. The computer program product of claim 15, wherein the resource consumption comprises usage of an appliance.
